(19) United States
(12) Patent Application Publication
(10) Pub. No.: US 2021/0198158 A1
(43) Pub. Date: Jul. 1, 2021

(54) POLYMER AND POROUS INORGANIC COMPOSITE ARTICLE AND METHODS THEREOF

(71) Applicant: Corning Incorporated, Corning, NY (US)

(72) Inventors: Jennifer Anella Heine, Hammondsport, NY (US); Dayue Jiang, Painted Post, NY (US); Weiguo Miao, Horseheads, NY (US); Ying Zhang, Horseheads, NY (US)

(21) Appl. No.: 16/757,723

(22) PCT Filed: Oct. 22, 2018
(86) PCT No.: PCT/US2018/056904

§ 371 Date: Apr. 20, 2020

Related U.S. Application Data
(60) Provisional application No. 62/578,080, filed on Oct. 27, 2017.

(51) Int. Cl. C04B 41/48; C04B 41/00; C04B 41/45; C04B 41/83

(52) U.S. Cl. CPC C04B 41/4896; C04B 41/009; C04B 41/83; C04B 41/4556; C04B 41/4876

(57) ABSTRACT

An inorganic circuit board article including: a porous inorganic sheet having a low dielectric loss of from 1×10⁻⁵ to 3×10⁻³ at a high frequency of from 10 to 30 GHz and the porous inorganic sheet has a percent porosity of from 30 to 50 vol %; a dielectric polymer having a low dielectric loss of from 10⁻⁴ to 10⁻³ at a high frequency of from 10 to 20 GHz, wherein the dielectric polymer occupies the pores of the porous inorganic sheet, and the inorganic circuit board article has a dielectric loss of from 1×10⁻⁴ to 9×10⁻⁴. The disclosure also includes methods of making and using the inorganic circuit board article.

This application claims the benefit of priority under 35 U.S.C. § 119 of U.S. Provisional Patent Application No. 62/578,080, filed Oct. 27, 2017, the content of which is incorporated herein by reference in its entirety.

### CROSS-REFERENCE TO RELATED APPLICATIONS

The disclosure relates to commonly owned and assigned application(s) or patent(s): U.S. Provisional Patent Application Nos. 62/367,301, filed Jul. 27, 2016, entitled “Ceramic and Polymer Composite, Methods of Making, and Uses Thereof” and 62/436,130, filed Dec. 19, 2016, entitled “Self-Supported Inorganic Sheets, Articles, And Methods Of Making The Articles,” but do not claim priority thereto.

The entire disclosure of each publication or patent document mentioned herein is incorporated by reference.

### BACKGROUND

The disclosure relates to a polymer-inorganic hybrid circuit board article, and to a method of making and using the article.

### SUMMARY

In embodiments, the disclosure provides a polymer-inorganic hybrid circuit board article including a porous inorganic substrate that is infiltrated with a dielectric polymer for a dielectric application, and the article having a low dielectric loss (e.g., less than about 6×10⁻⁴) property at a high frequency (e.g., greater than 10 GHz).

In embodiments, the disclosure provides a method of making the polymer-inorganic hybrid circuit board article comprising: infiltrating a polymer having a low dielectric loss at a high frequency into a porous inorganic sheet, which sheet also has a low dielectric loss at a high frequency. The resulting polymer infiltrated inorganic sheet article shows a low dielectric loss at a high frequency, as defined herein, demonstrating the utility for a printed circuit board (PCB) article and PCB applications (alternatively referred to as an inorganic circuit board (ICB) article). For example, an ICB, prepared by infiltrating polystyrene (PS) into a porous silica sheet, shows a dielectric loss of from 4 to 6×10⁻⁴ or lower at from 10 GHz to 30 GHz, which is superior to the best presently used commercial PCBs, such as PTFE/woven glass/ceramic based PCBs, which has a dielectric loss of about 2×10⁻³ at 1 GHz.

In embodiment, the disclosure provides a method of introducing inorganic nanoparticles into, for example, a PS or copolymer of styrene/DVB to make a disclosed hybrid of a porous substrate having its pores filled with a mixture of a polymer and inorganic nanoparticles. In embodiment, the inorganic nanoparticles can be, for example, included with the infiltrating polymer, generated in situ by sol-gel techniques, or both.

### BRIEF DESCRIPTION OF THE DRAWINGS

In embodiments of the disclosure:

FIG. 1 shows a comparison of known composite structures (100) and (120), and the disclosed composite (140).

FIG. 2 shows a bar chart of the dielectric loss of disclosed PS polymers prepared with different methods in accordance with the disclosure.

FIG. 3 shows a bar chart of the dielectric loss of a bare silica sheet, a PS, and three examples of a PS infiltrated silica sheet at 10 GHz.

FIG. 4 shows a bar chart of the dielectric loss Df of a PS infiltrated silica sheet 1 at 10 GHz and at 20 GHz.

FIG. 5 shows a twinned bar chart of measured dielectric loss Df of a duplicate PPO/PS infiltrated silica sheet and a duplicate PPO infiltrated silica sheet at 10 GHz and 22.7 GHz.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### Definitions

“PPE,” “PPO,” or like terms or abbreviations refer to polyp-phenylene oxide) or polyp-phenylene ether).

“PS,” or like terms abbreviations refer to polystyrene.

“Hybrid” or like terms refer to a porous inorganic sheet having a polymer filling.

“Dielectric loss” and like terms refer to a dissipation factor (Df) or a loss tangent that quantifies a dielectric material's inherent dissipation of electromagnetic energy, such as heat.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

Traditionally, printed circuit board (PCB) for radio-frequency (RF) or microwave applications were developed based on the needs of the military market. In the 1950s, PTFE based, combined with glass, dielectric circuits with low dielectric constants began to emerge in the military market. In the 1990s, temperature-stable PTFE/ceramic composites were developed. At the same time, a new type of resin system—a thermoset resin was introduced into the circuit board. A timeline showing the evolution of CB materials developed has been reported (see Advances in High-Frequency PCB Materials Volume 4, No. 5, October 2010 Engineering Solutions for Military and Aerospace, DEFENSE® Tech Briefs).

With advances of electronic devices civil applications also demanded PCB materials having a better performance. The RF/microwave market has been dominated by the wireless telecom market, which dictates the types of usable PCB materials. Further, the increasing complexity of electronic components and switches continually requires faster signal flow rates, and higher transmission frequencies. Because of short pulse rise times in electronic components, it has also become necessary for high frequency (HF) technology to view conductor widths as an electronic component. Commercially available PCB materials are dominated by thermoset/ceramic/woven glass or PTFE/ceramic/woven glass based materials and have a dielectric loss at n×10⁻³, where n=1, 2, 3, 4, . . . 9, at 1 GHz, and over time have been unable to meet such a requirement with respect to the dielectric performance.

Bonding materials, properties, and selection criteria used for fabricating high-frequency multilayer PCBs are known (see for example, edn.com/Home/PrintView?contentItemId=4390174), such as PTFE with microglass fiber or woven glass, ceramic—filled PTFE, ceramic-filled PTFE with woven glass, ceramic-filled hydrocarbon, and ceramic-filled hydrocarbon with woven glass.

Chen-Yang, et al., High-performance circuit boards based on mesoporous silica filled PTFE composite materials, Electrochemical and Solid-State Letters (2005), 8(1), F1-F4, mention a series of composite materials based on a hydrophobic mesoporous silica (MCM-41-m) filled with polytetrafloroethylene (PTFE).

In embodiments, the disclosure provides an composite circuit board article comprising:

a porous inorganic sheet having a low dielectric loss of from 1×10⁻⁵ to 3×10⁻³ at a high frequency of from 10 to 30 GHz such as from 10 to 25 GHz, from 15 to 23 GHz, from 17 to 22 GHz, and like frequencies, and the porous inorganic sheet has a percent porosity of from 30 to 50 vol %; and

a dielectric polymer having a low dielectric loss of from 10⁻⁴ to 10⁻³ at a high frequency of from 10 to 20 GHz, wherein the dielectric polymer occupies the pores of the porous inorganic sheet.

In embodiments, the inorganic circuit board article can have a dielectric loss, for example, of from 1×10⁻⁴ to 9×10⁻⁴.

In embodiments, the porous inorganic sheet can be selected from, for example, porous silica, and porous alumina, and the polymer is a homopolymer or copolymer selected from, for example, PPO, modified PPO, PS, cross-linked PS, TOPAS; PP; SPS; PEEK; PEI; a polyolefin, a liquid crystal polymer aromatic amide, a liquid crystal polymer ester, e.g., ARAMID®, a liquid crystal polymer amide, fluoropolymers (e.g., PTFE) and mixtures or blends thereof.

In embodiments, TOPAS is a superior polymer filler pair for the composite having a D_{f} at 1×10⁻⁴ (see for example, topas.com/tech-center/performance-data/electricalelectronics).

In embodiments, the article can further comprise, for example, a nanoparticle dispersed in the dielectric polymer in an amount of from 1 to 10 wt % based on superaddition to 100 wt % of the porous inorganic sheet and the dielectric polymer.

In embodiments, the nanoparticle dispersed in the dielectric polymer can be, for example, a polymer, an inorganic, or a combination thereof.

In embodiments, the surfaces of the porous inorganic sheet can have a compatibilizer, i.e., treated with a reactive agent to compatibilize the polymer in the pores of the porous inorganic sheet (e.g., silanizing).

In embodiments, the article can be, for example, a board having one or more integrated circuits.

In embodiments, the present disclosure provides a composite article comprised of a dielectric polymer infiltrated (or combined in any suitable alternative manner) into a porous inorganic sheet, for example, using a porous silica sheet as the porous inorganic sheet or substrate, and a polystyrene or PPO as the dielectric polymer. Based on the performance of the composite (i.e., a measured dielectric loss at n×10⁻⁴, n=1, 2, 3, . . . 9, at 10 GHz or higher, which much better than that of the presently available commercial PCBs), the composite can be used as a PCB at a high frequency in a variety of applications.

In embodiments, the disclosed compositions, composites, articles, and methods are advantaged by, for example:

Performance: the achieved dielectric polymer-infiltrated inorganic circuit board shows a very low dielectric loss at a high frequency, which property is superior to the commercially available PTFE/ceramic/woven glass based or thermoset/woven glass/ceramic based PCBs, such as n×10⁻⁴ vs. n×10⁻³ for the dielectric loss, where n is an integer, for example, from 1 to 9.

The structure of the disclosed composite is fundamentally different from conventional PCB composite products because the inorganic component is a continuous phase and can provide mechanical support for the PCB board, which support enable polymers having a lower T_{g} to be processed at higher temperature without melting and flowing.

The disclosed polymer infiltrated porous ceramic sheets keep the low dielectric loss (Df at 2 to 4×10⁻⁴ for a frequency at 10 GHz or higher) and other properties, but having a superior thermal stability and mechanical properties.

Commercially available PCBs for the high frequency application are primarily based on ceramic that is filled with a PTFE that has a dielectric loss of n×10⁻³ where n is 1 to 9 at 1 GHz. With the advance of the electronic devices and increasing applied frequencies, the ceramic filled PTFE cannot meet future requirements.

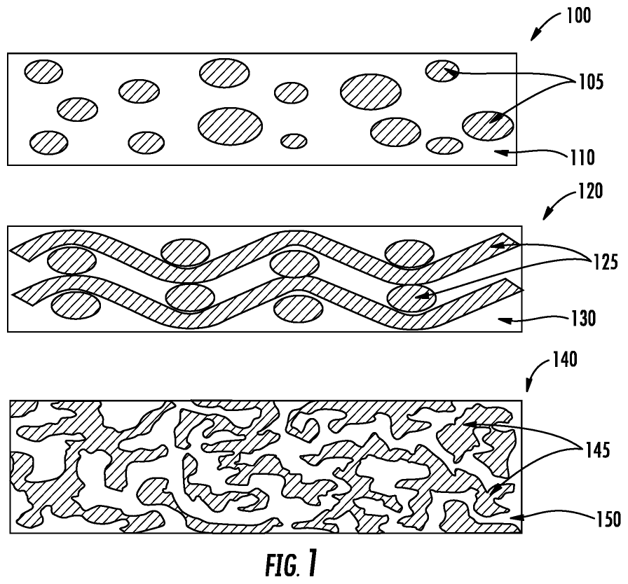

Referring to the figures, FIG. 1 is a schematic summary of known (i.e., prior art) structures of commercially-available PCBs (100) and (120), and a structure of the disclosed composite (140). The polymer-inorganic filler composite structure (100) has a continuous polymer phase (110) that is filled with dispersed inorganic filler particles (105). The polymer impregnated with woven fiberglass structure (120) has a continuous polymer phase (130) that is filled or impregnated with woven fiberglass fibers (125). The disclosed interpenetrating bi-continuous polymer and porous inorganic composite structure (140) has an interpenetrating bi-continuous network of an inorganic phase (145) such as silica, and an organic phase (150) such as a polymer. In embodiments, the disclosed composite structure (140) can additionally include inorganic nanoparticles dispersed in the polymer phase.

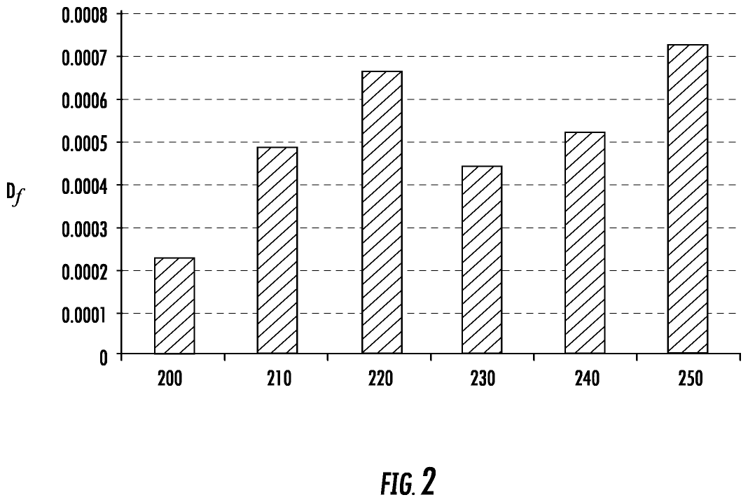

FIG. 2 shows a bar chart of the dielectric loss of disclosed polystyrene (PS) polymers including PS1 (200), PS2 (210), PS3 (220), PS4 (230), PS5 (240), and PS6 (250), that were prepared by different methods and as summarized in Table 2.

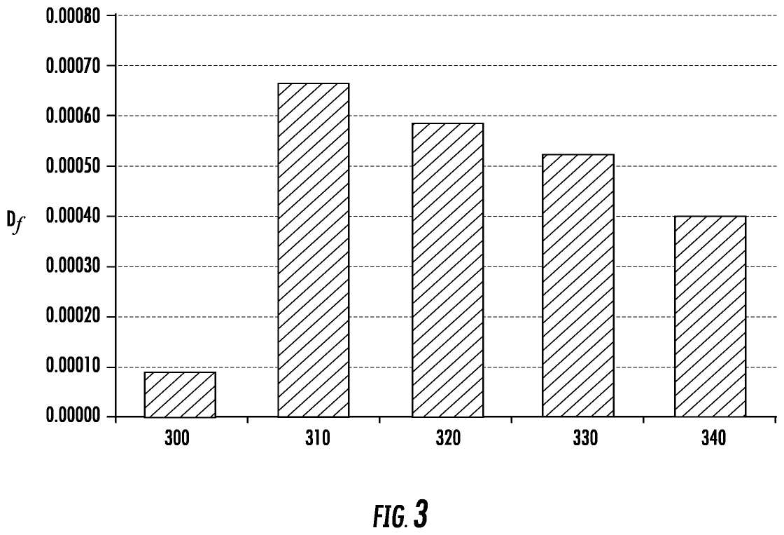

FIG. 3 shows a bar chart of the dielectric loss of a bare silica sheet (300), polystyrene (310), polystyrene infiltrated silica sheet 1 (320), polystyrene infiltrated silica sheet 2 (330), and polystyrene infiltrated silica sheet 3 (340), all at 10 GHz.

The porous silica sheets can be made by tape casting silica nanoparticles and then sintered at elevated temperature, see for example, Example 1 below. In embodiments, a PS and styrene solution was used to infiltrate the PS polymer into a porous silica sheet. The polymer can be, for example, of from 5 to 50 wt %, and preferably, of from 15 to 25 wt %, see Example 2 below entitled “Polymer infiltration and polymerization without surface modification of the substrate.” The solvent can be, for example, the balance of weight of the polymer and solvent solution. In embodiments, the co-monomer styrene can be replaced by a non-polymerizable solvent, e.g., toluene. Toluene solutions having a polymer such as PS, PPO, PS/PPO, PS/PPO/Noryl, Noryl, and like polymers, can be used to infiltrate a porous silica sheet. The infiltration can be accomplished, for example, at room temperature by dip coating the porous silica sheet into the polymer and toluene solution, and then dried at room temperature. NORYL® is a family of modified PPE resins of amorphous blends of PPO polyphenylene ether (PPE) resin and polystyrene.

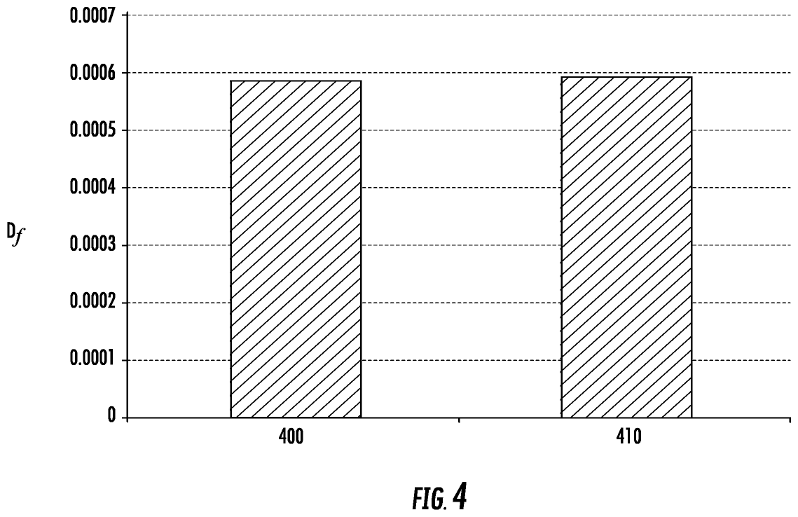

FIG. 4 shows a bar chart of the dielectric loss Df of a PS infiltrated silica sheet 1 at 10 GHz and at 20 GHz.

Methods used for making commercial PCBs, include, for example: 1) preparing a polymer-ceramic composite by mixing ceramic powder into a dielectric polymer to improve a thermal property such as softening point, and increase the mechanical strength (however, the continuous phase is a polymer and the discrete phase is ceramic powder); and 2) woven fiberglass that is infiltrated/coated with dielectric polymers and a different strand of woven fibers have been known (see J. Loyer, et al, “Fiber Weave Effect: Practical Impact Analysis and Mitigation Strategies”, DesignCon 2007) to cause skewing and plating problems for high frequency PCB applications.

In embodiments, the present disclosure provides a dielectric polymer infiltrated into a porous silica sheet or a ceramic sheet.

In embodiments, the resulting polymer-infiltrated inorganic sheet has a low dielectric loss at n×10⁻⁴ where n is from 1 to 9, at a frequency of 10 GHz or higher, which is several orders of magnitude better than the commercially available PCBs. Compared to existing products, the presently disclosed composite structure having a continuous inorganic phase and internal phase of a uniform polymer network can provide mechanical support for the PCB board, which enables some lower T_{g} polymers to be selected and processed at higher temperatures without melt, flow, or like issues.

In embodiments, the disclosure provides:

a polymer-infiltrated porous inorganic sheet (“hybrid”) as, for example, a circuit board article having a low dielectric loss at a high frequency. The porous sheet or porous substrate can be, for example, a porous ceramic, a glass-ceramic, or a glass sheet. The polymer can be, for example, a dielectric polymer having a low dielectric loss at a high frequency, as defined herein.

Representative polymers having a low Df/Tan δ (see topas.com/tech-center/performance-data/electricalelectronics) include, for example, TOPAS a family of cyclic olefin copolymers (COC) including a cyclic olefin and a linear olefin, for example, a bi-cyclic olefin norbornene and ethylene; PTFE a family of polytetrafluoroethylene polymers; PP polypropylene polymers; PS a family of polystyrene polymers; SPS a family of syndiotactic polystyrene polymers; PEEK a family of polyetheretherketone polymers; PEI a family of polyetherimide polymers; liquid crystal polymers (LCP) such as the commercial aramid fiber polymers known as Kevlar®, and like polymers.

Dielectric inorganics suitable for the porous inorganic sheet or substrate are known and include, for example, silica, alumina, boron nitride, mica, and mixtures thereof (see Polymeric Dielectric Materials—InTech (cdn.intechopen.com/pdfs-wm/39574.pdf)).

The following exemplary materials were used in the working examples:

Substrate: a porous silica sheet was used as a representative porous sheet (see for example the abovementioned Provisional Patent application Ser. No. 62/367,301).

Dielectric polymer: a polystyrene, or a crosslinked or un-crosslinked polystyrene, was prepared starting from styrene monomer or from commercial PS.

Dielectric Polymer preparation: PS is a known dielectric polymer that has been widely used for a high frequency application. Rexolite® (originally registered as Texoke®) is made from the PS, and polymerized by irradiation. In the present disclosure, three alternative processes were used to make PS polymer or a monomer mixture, which polymer or mixture was then infiltrated into the porous silica sheet and then cured, for example, at 80 to 90° C. for 16 hrs in air or N₂.

Procedure 1: Starting from styrene monomer. Inhibitor-free styrene was partially polymerized with 0.1 wt % BPO initiator at 80 to 90° C. for about 6 hrs, cooled to ambient temperature, and then DVB was added (at about 30:70 wt %=DVB:PS) to obtain a PS/styrene/DVB mixture for infiltration use.

Procedure 2: Starting from commercial PS (e.g., Styron™ 585 D from Styron LLC and MC3650 from Americas Styrenics LLC). The commercial PS was dissolved in inhibitor free styrene (Aldrich). The inhibitor, tert-butylcatechol, was removed by passing the inhibited styrene monomer down a column containing inhibitor remover (Aldrich Cat. No. 306320) to prepare a 30 to 35 wt % PS in styrene solution. Alternatively, the PS can be dissolved in styrene and then styrene can be added having, e.g., 0.05 wt % BPO initiator. In embodiments, divinylbenzene (DVB) or a mixture of DVB and styrene at any ratio can be used in place of styrene alone so that a crosslinked PS is obtained. Alternatively or additionally, a solvent that can dissolve the PS such as toluene, can be used to replace the styrene in forming the PS solution.

Procedure 3: Same as 1 or 2 above with the exception that the styrene, or a styrene/DVB mixture is polymerized with a pure thermal process, i.e., polymerized without an added initiator, at about 85° C. for 16 hrs.

The polymerization of styrene, and the copolymerization and cross-linking of styrene/DVB is known. The dielectric loss of PS prepared with different processes is plotted in FIG. 2. The infiltration process can be accomplished by, for example, dip-coating a porous silica sheet into a PS solution and then curing in oven at 90° C. under N₂ protection, for example, for 2 hrs to 7 days. All data was generated from the prepared polymers.

Photos (not shown) of a porous silica sheet used in this work before being infiltrated with the PS was opaque and after infiltrated with the PS was translucent or partially transparent. In embodiment, the porous silica sheet can be opaque prior to infiltration. After polymer infiltration of the porous sheet with polymer, the composite can become translucent or partially transparent (i.e., seen by a human observer). The polymer refractive index better approximates the refractive index of the silica and renders the composite translucent or partially transparent. In embodiments, the silica sheet can be opaque because of its porosity property. After infiltrating the filled silica sheet can become translucent because refractive indices of the sheet and the polymer are closer together than the porous sheet filled with air.

FIG. 3 shows a bar chart of the dielectric loss of a bare silica sheet, a PS, and three examples of a PS infiltrated silica sheet at 10 GHz (see Table 3).

Performance (dielectric loss) of the porous silica sheet, pure PS, and PS infiltrated silica sheet prepared in this work are shown in Table 3, which is also plotted into FIG. 3. FIG. 4 shows a bar chart of the dielectric loss Df of a PS infiltrated silica sheet 1 at 10 GHz and at 20 GHz (see Table 3).

The dielectric loss at 10 GHz and 20 GHz for infiltrated sample 1 is plotted in FIG. 4. All the measured dielectric loss at high frequency is on the order of 10⁻⁴, which is an order lower than current commercially available products.

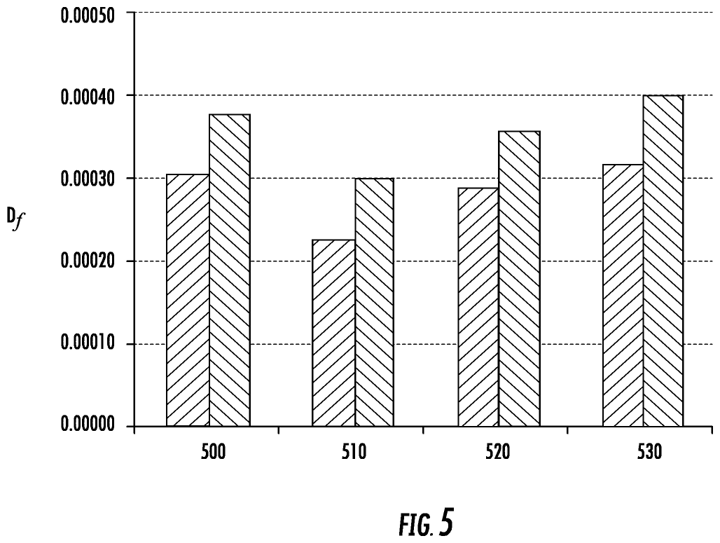

FIG. 5 shows a twinned bar chart of measured dielectric loss Df of a duplicate PPO/PS infiltrated silica sheet and a duplicate PPO infiltrated silica sheet at 10 GHz (left side twin) and 22.7 GHz (right side twin).

In embodiment, the surface of the inorganic substrate can be modified by introducing, e.g., imbibing or infiltrating, a functional silane by contacting the surface of the inorganic substrate with the silane, such as HMDS.

The introduction of silane onto the surface of inorganic substrate can be carried out, for example, by a known the sol-gel reaction. Sol-gel introduction provides at least three major advantages:

1) the surface of inorganic substrate is made more hydrophobic and prevents water adsorption, which water can increase dielectric loss. Inorganic substrate can have surface hydroxide groups, which groups are hydrophilic and moisture is inevitably absorbed on the surface, and the moisture can affect the dielectric property. Hydrophobizing the surface, e.g., with a hydrophobic silane, can prevent the substrate from absorbing water and little or no moisture is absorbed on the surface of the inorganic substrate.

2) the wettability of the porous substrate is increased to improve polymer infiltration. Capillary force can be a significant driving force for polymer infiltration. For a porous substrate made of micron or sub-micron sized pores it is significant to have a wettable surface; and

3) the interaction/adhesion between the substrate and the polymer can be improved. In embodiments of the disclosure, styrene/DVB, PS/styrene, PS/DVB, PS/styrene/DVB, or combinations thereof, can be used as the polymer to demonstrate infiltration.

In embodiments, a reactive silane is preferred, for example, a styrylethyltrimethoxysilane (i.e., a vinyl and alkyltrialkoxysilane ortho-substituted phenyl), such as a styrene-based silane of the formula:

CH₂═CH—C₆H₄—CH₂—CH₂—Si(OCH₃)₃

The reactive silane, such as a silane attached to the porous substrate surface by a sol-gel reaction, can act as the crosslinker when styrene/DVB is polymerized and this can improve the substrate-polymer interaction because of covalent bonding, and also benefits the thermal/mechanical property of the product article.

It is believed that other reactive silanes, e.g., epoxy silanes and vinyl silanes, can also be selected and used for modifying the porous substrate.

In embodiments, the disclosure provides an article and a method of making the article comprising: infiltrating a mixture of inorganic nanoparticles and a dielectric polymer into a porous inorganic substrate. The inorganic nanoparticles can be surface modified or un-modified.

Surface Modified or Un-Modified Substrate: Porous Inorganic Sheet.

Polymer Filler: a dielectric polymer with low dielectric loss at a high frequency, but additionally containing inorganic nanoparticles, added or in-situ formed, surface modified or un-modified.

The added nanoparticles can be, for example, silica, alumina, POSS, and like materials. Preferably the added nanoparticles have the same composition as the substrate, e.g., if the substrate is silica based, then the nanoparticles are preferably silica containing or Si based, e.g., silica nanoparticles or POSS.

When a surface modification of the nanoparticles is applied, the modifier (usually a silane) is preferably to be compatible with the dielectric polymer, e.g., silane containing phenyl group compared to PS, or phenyl-modified POSS of the formula:

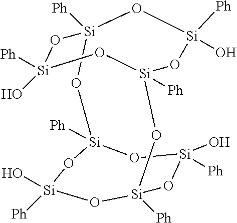 [SMILES: O[Si]1(c2ccccc2)O[Si]2(c3ccccc3)O[Si](O)(c3ccccc3)O[Si](c3ccccc3)(O1)O[Si]1(c3ccccc3)O[Si](O)(c3ccccc3)O[Si](c3ccccc3)(O[Si](O)(c3ccccc3)O1)O2]

compared to PS. More preferably the modifier contains one or more reactive groups, e.g., vinyl groups, e.g., styryl silane.

In embodiments, the in-situ formed silica nanoparticle can be made from a silane. An alkoxysilane hydrolyzes and reacts with other alkoxysilanes through the sol-gel chemistry to form an inorganic particle or gel, depending on the concentration and reaction condition. For example, the abovementioned styrylethyltrimethoxysilane results in a styryl-functionalized silica particle (see Scheme I), when self-reaction (e.g., sol-gel chemistry) conditions are selected.

Scheme I. Formation of a surface functionalized silica core nanoparticle by trialkoxysilane-self reaction.

CH₂—CH—C₆H₄—CH₂—CH₂—Si(OCH₃)₃→{CH₂═CH—C₆H₄—CH₂—CH₂—Si≡}ₙ═{CH₂═CH—C₆H₄—CH₂—CH₂—}ₙ (SiO₂ nanoparticle)

A vinyl and alkyltrialkoxysilane ortho-substituted phenyl compound is oligomerized and condensed as shown in the Scheme I equation, where n is, for example, from 3 to 20, 3 to 15, 4 to 10, and like values, and represents the number of oligomerized and condensed vinyl and alkyltrialkoxysilane ortho-substituted phenyls in a silica core nanoparticle.

The surface functionalized inorganic nanoparticles can function as a crosslinker. An advantage of infiltrating a mixture of inorganic nanoparticles and PS into the porous inorganic substrate provides a PCB with improved thermal properties, e.g., Tg, decomposition temperature, or both.

TABLE 2
Dielectric loss of disclosed PS filled sheet
at 10 GHz prepared by different methods.

| PS | Frequency | thickness | | | PS Preparative |
|---|---|---|---|---|---|
| Sample | GHz | mm | Dk | Df | Description or source |
| PS1 | 9.993 | 0.450 | 1.384 | 0.00023 | styrene with 0.1% |
| | | | | | BPO, N₂, cured 7 days |
| PS2 | 9.952 | 0.746 | 1.459 | 0.00049 | styrene with 0.1% |
| | | | | | BPO, N₂, cured 7 days |
| PS3 | 9.916 | 0.444 | 2.248 | 0.00067 | styrene with 0.1% |
| | | | | | BPO, N₂, cured in air |
| PS5 | 9.862 | 0.955 | 1.786 | 0.00045 | commercial PS (685D) |
| | | | | | dissolved in styrene |
| PS5 | 9.882 | 0.554 | 2.248 | 0.00053 | commercial PS (365D) |
| | | | | | dissolved in styrene |
| PS6 | 9.978 | 0.165 | 2.636 | 0.00074 | styrene with thermal |
| | | | | | process, cured 2 days, |
| | | | | | air |

TABLE 3
Dielectric loss of bare silica sheet, PS, and
PS infiltrated silica sheet at 10 and 20 GHz.

| | Frequency | thickness | | | |
|---|---|---|---|---|---|
| Sample | GHz | mm | Dk | Df | Description |
| Silica | 9.937 | 0.414 | 2.086 | 0.00009 | Bare silica sheet, |
| sheet | | | | | non-aqueous |
| | | | | | casting sample |
| PS | 9.916 | 0.444 | 2.248 | 0.00067 | PS/DVB (80/20, |
| | | | | | wt/wt) and 0.1 |
| | | | | | wt % BPO, air |
| Infiltrated 1 | 9.899 | 0.955 | 1.786 | 0.00045 | PS infiltrated |
| | | | | | silica sheet |
| Infiltrated 1 | 19.38 | 0.554 | 2.248 | 0.00053 | PS infiltrated |
| | | | | | silica sheet |
| Infiltrated 2 | 9.947 | 0.230 | 2.817 | 0.00053 | PS infiltrated |
| | | | | | silica sheet |
| Infiltrated 3 | 9.934 | 0.330 | 2.430 | 0.00041 | PS infiltrated |
| | | | | | silica sheet |

In embodiments, the disclosure provides composite comprising a PPO, or a PPO/PS polymer infiltrated porous ceramic sheet having a low dielectric loss, i.e., dissipation factor (D_{f}) at n×10⁻⁴ (where n is from 1 to 9), for use in, for example, a printed circuit board (PCB) at a frequency of 10 GHz or higher. The composite has improved thermal and mechanical properties compared to prior art composites.

A leading high frequency and low loss commercial PCB board material available from Rogers Corporation is a PTFE/ceramic powder/glass fabric, which is prepared by an aqueous PTFE dispersion/emulsion that was dispersed with ceramic powders and then coated onto a woven glass fabric and cured. This PCB had two major problems: firstly, a tangent loss (Df) at n×10⁻³ at 1 GHz although the PFTE itself is one of the best polymers and has a Df at n×10⁻⁴ at 1 GHz or a higher frequency. The high Df may be due to moisture trapped in the PCB. The moisture is usually unable to escape after being trapped even though the PTFE has excellent hydrophobicity. This trapping property makes the PCB unsuitable to satisfy the increasing requirements of PCBs for high frequency applications; and secondly, a poor bonding property with copper foil.

The disclosed dielectric polymer infiltrated porous ceramic sheet composite for PCB applications target the following properties:

1) electrical: an excellent dielectric performance (targeting a Df at n×10⁻⁴ with a frequency of 10 GHz or higher, where “n” is an integer from 1 to 9;

2) thermal: able to endure the welding temperature (this typically requires the infiltrated polymer to have a Tg of 150° C. or higher;

3) mechanical: no breaking during the post processing/handling;

4) bonding: able to bond well to copper foils; and

5) infiltrating: the polymer can be a liquid or a solution and can be easily infiltrated into the porous sheet.

The disclosed PS infiltrated porous ceramic sheet can possess all the above target properties, for example, having an excellent dielectric property with a Df at 3 to 5×10⁻⁴. However, a potential concern about a PS infiltrated porous ceramic sheet is that the PS has a Tg at about 100° C., which Tg, for a non-crosslinked PS, is perhaps low for an actual PCB article and use.

To improve the Tg of a PS, several methods can be used and include, for example: firstly, crosslink the PS since the PS increases its Tg with an increase in crosslinking density; secondly, mix the PS with a high Tg polymer that also has a low dielectric loss at a high frequency (1 GHz or higher), for example, PPE; and thirdly, replace the PS with a high Tg polymer, for example, modified PPE, e.g., Noryl® from SABIC, that also has a low dielectric loss at a high frequency (1 GHz or higher).

Crosslinking the PS can be accomplished with a crosslinker, for example, divinyl benzene (DVB), or other like monomers or polymers containing divinyl groups, in the styrene polymerization. For either the mixing or the replacement Tg improvement method mentioned above, mixing the PS with a high Tg polymer, or replacing the PS with a high Tg polymer, such as poly(p-phenylene oxide) (PPO) (aka.: poly(p-phenylene ether) (PPE)), is an excellent choice.

PPO is a high-temperature thermoplastic having a low dielectric loss (e.g., Df at about 7×10⁻⁴ at a frequency of 1 GHz). PPOs most notable property is its resistance to high temperatures. PPO has a high glass transition temperature of 210° C. Structurally (see Scheme II), PPO is made of phenylene rings linked together by ether linkages in the 1,4 or para-positions, and a methyl group attached to carbon atoms in the 2 and 6 ring positions.

PPO is completely miscible with PS at any ratio because of the phenyl groups in both polymers. The Tg of resulting PPO/PS blends are between that of PS and PPO alone, depending on the ratio of PPO to PS (see FIG. 2). Modified PPO materials (such as from SABIC), are blends of PPO and PS, in which three polymers are present: PPO, PS, and a PPO-PS copolymer (see Scheme III), because of polymer chain scissions and recombination. Different combinations of each, along with possible additive packages, make it possible to produce materials having a wide range of physical and mechanical properties, heat resistance, and flame retardancy. The modified PPO materials are polymers (available from SABIC) having heat distortion temperatures, for example, of from 170 to 460° F. (77 to 23 8° C.) and having a flammability range from UL-94 HB to V0.

Because of the water-resistant nature of the two major resin components, PPO/PS alloys/blends have low moisture absorption levels, the blends have good electrical properties over a wide range of humidity and temperature ranges. The blended materials have good chemical resistance, though softening and cracking can occur with exposure to some organic chemicals. PPO blends can be used, for example, for structural parts, electronics, house hold and automotive items that rely on having high heat resistance, dimensional stability, and accuracy.

In embodiments, the present disclosure provides a polymer-inorganic composite article having single polymer of PPO or PS (e.g., PPO alone, prepared into 20% styrene or toluene solution), or a mixture of two polymers PPO and PS (e.g., PPO/PS at 50/50 (wt/wt), prepared into 20% styrene or toluene solution), infiltrated into a porous silica sheet. The infiltrated polymer-inorganic composite articles can be used as inorganic circuit board (ICB) articles.

The polymer infiltrated silica sheets of the disclosure have an excellent dielectric property such as a Df at from 2 to 3×10⁻⁴ for a frequency of 10 and 23 GHz (see Table 2 and FIG. 3). It is believed that, in addition to the polymer systems mentioned above, other PPO based systems, e.g., modified PPO (e.g., both PS or polyolefin modified), mixtures of PPO/PS, and modified PPO mixed with other dielectric polymers, e.g., TOPAS®—a cyclic olefin copolymer that has limited solubility in toluene and styrene, can also be used (see Table 3).

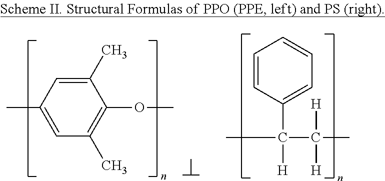

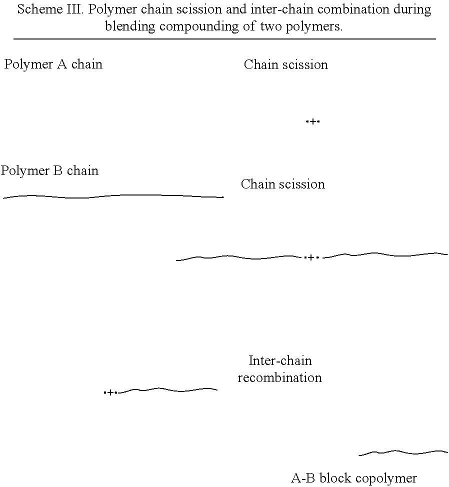

The glass transition temperature (Tg) of DVB crosslinked polystyrene beads has been reported, for example, wt % DVB: wt % PS, Tg: 0:100, 104.4° C.; 1:99, 107.1° C.; 2:98, 110.2° C.; 5:95, 112.2° C.; 10:90, 133° C. (see, for example, D. Zou et al, “Model Filled Polymers I. Synthesis of Crosslinked Monodisperse Polystyrene Beads” Journal of Polymer Science, Part A: Polymer Chemistry, Volume 28, Issue 7 Jun. 1990 Pages 1909-1921 DOI: 10.1002/pola.1990.080280722).

In embodiments, the disclosure provides a slip composition and process for preparation of a slip system for silica tape casting. The slip is both nonaqueous and slightly non-polar to non-polar. The slip is comprised of at least one of the abovementioned: solvents such as methoxy propyl acetate (MPA); a binder such as polyvinyl butyral binder (PVB); a plasticizer such as dibutyl phthalate (DP); and a dispersant such as menhaden fish oil (MFO). MPA is an ether acetate solvent having a vapor pressure of 2.5 mm Hg and a density of 0.980 g/cc. MPA is an excellent solvent for a polyvinyl butyral binder system due to the similarity of ether and acetate functional groups. A PVB binder having specific properties was selected for this slip. Butvar B79 with the lowest OH functional group content (in the form of polyvinyl alcohol 11 to 13 wt %) relative to acetate group content (poly vinyl acetate) was used for the best solubility since it is the least polar. The Butvar B79 binder system also has low molecular weight (50,000 to 80,000 g/mol) relative to other PVB binder systems. This allowed for reduced slip viscosity and enabled higher solids loadings. Dibutyl phthalate (DP) plasticizer was used to lower the glass transition temperature (Tg) of the slip to approximately −3.5° C. contributing to the flexibility. The storage modulus at 25° C. of the green tape was approximately 4.603×10⁸ for silica.

### EXAMPLES

The following Examples demonstrate making, use, and analysis of the disclosed article and methods in accordance with the above general procedures.

### Example 1

### Preparation of a Porous Sheet

Slip formulation. For a silica composition: A Mazerustar mixer was used to disperse the silica powder into methoxy propyl acetate (i.e., MPA) solvent and fish oil (e.g., menhaden fish oil (MFO)) dispersant. Binder (e.g., Butvar B-79) and plasticizer (e.g., dibutyl phthalate) were added to the dispersion and mixed further with the Mazerustar mixer until the binder and plasticizer were dissolved to produce a slurry. The slurry was added to an attrition mill containing 2 mm YTZ media and milled for 2 hrs at 1000 to 2000 rpm to further disperse the ingredients and reduce agglomeration to produce a slip. The slip was filtered through a 10 micron filter. The slip was rolled on rollers for approximately 16 hrs to remove any entrained air. A tape was cast immediately after rolling. The slip was tape cast on continuous caster using a doctor blade set to a desired thickness (e.g., 4 to 32 mil). The tape caster can be preferably heated to approximately 60 to 80° C. and the linear speed of the caster was set to approximately 13 in/min to allow the resulting tape to dry in a continuous process.

### Example 2

Polymer Infiltration and Polymerization without Surface Modification of the Substrate

A porous silica sheet is infiltrated by a PS/styrene solution, e.g., a 30% PS/70% solution prepared by dissolving 30 g PS is 70 g styrene containing 0.1 to 0.5% BPO, through a dip-coating process (i.e., immersing the porous sheet in the PS/styrene solution for 5 min) and then the PS/styrene solution infiltrated porous sheet is put in a closed container, and the container is placed into an oven (preheated to 90° C.), for example, for several hrs to 7 days in air or in a nitrogen atmosphere.

### Example 3

Polymer Infiltration and Polymerization with Surface Modification of the Substrate

The surface modification is accomplished by immersing the porous silica sheet into a 5 wt % silane (e.g., styrylethyltrimethoxysilane) solution of alcohol/water (90/10) for 5 min and then dried at 25□ and then at 120□ for several hrs. The resulting dried and silanized porous silica sheet was infiltrated according to the procedure of Example 2.

### Example 4

Porous Silica Having Silane Treated Surface and then Filling (i.e., Infiltrating) with Polymer

A high Tg polymer (e.g., polyphenylene oxide, PPO, or modified PPO) that replaces PS or is mixed with PS can produce an infiltrated product of a porous silica sheet having improved thermal stability. The PPO alone or in admixture with the PS provides a polymer infiltrated porous silica sheet having a low dielectric loss, e.g., Df at from 2×10⁻⁴ to 4×10⁻⁴ for a frequency of 10 GHz or higher.

Materials Used and Source:

### PPO: SA-120, SABIC

### PS: MC3650, Americas Styrenics, LLC

Styrene: Aldrich. Inhibitor can be removed by passing through a column containing inhibitor remover.

### Toluene: Aldrich

Silica sheets: Porous surface modified by silane through sol-gel chemistry or un-modified. See Example 3. FTIR can be used for characterization of a silanized sheet, for example, prepared with a silane and having one or more phenyl groups is preferred to modify the external and internal surfaces of the sheet.

Polymer solution preparation and infiltration: Dissolve polymer(s) into styrene or toluene to obtain a 20 to 30 wt % solution. A dip infiltrating process was used to soak the porous ceramic sheets in the polymer solution for 10 to 20 mins and then air drying at 25° C.

Measurement of dielectric properties: The dielectric properties were measured with a microwave network analyser.

### Example 5

The following examples provide guidance of polymer infiltration of porous glass, porous glass-ceramic, or porous ceramic substrates, where the infiltrating polymer, the porous substrate, or both, do or do not include nanoparticles. If nanoparticles are included in the infiltrating polymer, the porous substrate, or both, the nanoparticles can be, for example, of from 1 to 15 wt %, preferably of from 2 to 10 wt %, and more preferably of from 3 to 5 wt % based on the total weight of the resulting polymer infiltrated and dried substrate (i.e., no longer porous). In embodiments, the nanoparticles can be surface modified, for example, by a silane such as through a sol-gel reaction, as mentioned in Example 3, and as discussed in the presently disclosed general procedures.

A PPO infiltrated polymer in a porous ceramic sheet, with or without nanoparticles, e.g., silica nanoparticles, such as surface modified silica nanoparticles or surfaces not modified with silica nanoparticles.

A mixture of PPO and PS polymers, or a PPO polymer that was structurally modified by PS, were each sample was separately infiltrated, with or without solvent, into a porous ceramic sheet. The polymer infiltrated porous ceramic sheet can have ceramic particles, such as nanoparticles, or not have ceramic particles. The ceramic particles such as nanoparticles, e.g., nanosilica, can be included in the polymer infiltration mixture. The ceramic particles can also be included and infiltrated in the pores the porous ceramic sheet prior to polymer infiltration. Either or both the porous ceramic sheet and the ceramic particles can be surface modified, e.g., by a reactive silane, or not modified. The surface modification of the ceramic sheet and the ceramic particles can have advantages, for example:

an improved hydrophobic property of the porous ceramic sheet and the ceramic particles and improved interaction of the polymer with the porous ceramic sheet and ceramic particles;

reduced absorption or reduced adsorption of moisture on the surface of porous ceramic and improved electrical and dielectric performance of the resulting sheet in various applications such as printed circuit boards or inorganic circuit boards.

A PPO/PS infiltrated polymer in a porous ceramic sheet in the presence of other dielectric polymers, including a PPO modified by polyolefin, with or without the presence of nanoparticles, e.g., silica nanoparticles, such as surface modified silica nanoparticles, or unmodified silica.

Tables 4 and 5 list, respectively, dielectric properties of the resulting PS/PPO polymer infiltrated porous silica sheets, and examples of the resulting infiltrated dielectric PS/PPO polymers.

TABLE 4
Dielectric properties of the resulting PS/PPO
polymer infiltrated porous silica sheets.

| Sample | Approximate | Frequency, | Thickness, | | |
|---|---|---|---|---|---|
| Name | Area | GHz | mm | Dk | Df |
| Porous silica | 60 × 60 mm | 9.955 | 0.166 | 3.327 | 0.00031 |
| sheet 1- | | 22.725 | | 3.436 | 0.00038 |
| PS/PPO | | | | | |
| Porous silica | 60 × 60 mm | 9.960 | 0.203 | 2.763 | 0.00029 |
| sheet 1-PPO | | 22.731 | | 2.851 | 0.00036 |
| Porous silica | 60 × 60 mm | 9.960 | 0.187 | 2.908 | 0.00023 |
| sheet 2- | | 22.734 | | 3.002 | 0.00030 |
| PS/PPO | | | | | |
| Porous silica | 60 × 60 mm | 9.961 | 0.171 | 3.083 | 0.00032 |
| sheet 2-PPO | | 22.738 | | 3.181 | 0.00040 |

Measurement Uncertainty

| | | |
|---|---|---|
| fundamental mode | Dk 1% | Df +/− 0.0001 |
| overtones | Dk 2% | Df +/− 0.0005 |

TABLE 5
Examples of resulting infiltrated dielectric PS/PPO polymers.

| Polymer | Description |
|---|---|
| PPO | PPO alone, a 20 wt % solution obtained by |
| | dissolving the PPO into a solvent, such as |
| | styrene or toluene |
| PPO/PS mixture | 20 wt % solution obtained by dissolving the |
| | PPO/PS mixture into a solvent, e.g., |
| | styrene or toluene |
| Modified PPO¹ | PS or polyolyolefin modifed PPO, e.g., |
| | Noryl from Sabic, prepared into a |
| | solution by dissolving the modified PPO |
| | polymer into a solvent, e.g., styrene or |
| | toluene |
| PPO/modified | 10-20 wt % solution obtained by dissolving |
| PPO | the PPO/modified PPO into a solvent, e.g., |
| | styrene or toluene |
| PS/modified PPO | 10-20 wt % solution obtained by dissolving |
| | the PS/modified PPO into a solvent, e.g., |
| | styrene or toluene |
| PPO/PS/modified | 10-20 wt % solution obtained by dissolving |
| PPO | into a solvent, e.g., styrene or toluene |
| TOPAS/polymer | TOPAS has limited solubilty in toluene and |
| system above | other solvents. Use the TOPAS with modified |
| | PPO or any of the above polymer pairs and |
| | adjust the solvent(s). |

¹“Modified PPO” in the disclosure refers to one or more of various PPO polymers for infiltration, such as see for example, the NORYL ® family of modified PPE resins which consist of amorphous blends of PPO ™ resin (polyphenylene ether) and polystyrene (see sabic-ip.com/gep/Plastics/en/ProductsAndServices/ProductLine/noryl.html).

The disclosure has been described with reference to various specific embodiments and techniques. However, it should be understood that many variations and modifications are possible while remaining within the scope of the disclosure.

What is claimed is:

1. A composite circuit board article comprising:
a porous inorganic sheet having a low dielectric loss of from 1×10⁻⁵ to 3×10⁻³ at a high frequency of from 10 to 30 GHz, and the porous inorganic sheet has a percent porosity of from 30 to 50 vol %;
a dielectric polymer having a low dielectric loss of from 10⁻⁴ to 10⁻³ at a high frequency of from 10 to 20 GHz, wherein the dielectric polymer occupies the pores of the porous inorganic sheet, and
the inorganic circuit board article has a dielectric loss of from 1×10⁻⁴ to 9×10⁻⁴.

2. The article of claim 1, wherein the porous inorganic sheet is selected from porous silica, and porous alumina, and the polymer is a homopolymer or copolymer selected from PPO, modified PPO, PS, cross-linked PS, a copolymer of a cyclic olefin and a linear olefin; PTFE; PP; SPS; PEEK; PEI; a polyolefin, a liquid crystal polymer aromatic amide, a liquid crystal polymer ester, a liquid crystal polymer amide, and mixtures or blends thereof.

3. The article of claim 1, further comprising a nanoparticle in an amount of from 1 to 10 wt % dispersed in the dielectric polymer, the amount based on superaddition to 100 wt % of the porous inorganic sheet and the dielectric polymer.

4. The article of claim 1, wherein the nanoparticle dispersed in the dielectric polymer is a polymer, an inorganic, or a combination thereof.

5. The article of claim 1, wherein the porous inorganic sheet is selected from porous silica, porous alumina, or a mixture thereof, and the polymer is at least one copolymer of a cyclic olefin and a linear olefin.

6. The article of claim 1, wherein the surfaces of the porous inorganic sheet has a compatibilizer.

7. The article of claim 1, wherein the article is a board having one or more integrated circuits.
